(19) United States
(12) Patent Application Publication
(10) Pub. No.: US 2025/0078001 A1
(43) Pub. Date: Mar. 6, 2025

(54) PRESENTATION OF RISK PROFILE

(71) Applicant: Wells Fargo Bank, N.A., San Francisco, CA (US)

(72) Inventors: Goutam Gandhi, Glen Allen, VA (US); Puneet Manaktala, Glen Allen, VA (US); Steven Wright, Maricopa, AZ (US)

(21) Appl. No.: 17/931,750

(22) Filed: Sep. 13, 2022

Related U.S. Application Data
(60) Provisional application No. 63/261,314, filed on Sep. 17, 2021.

(51) Int. Cl. G06Q 10/06

(52) U.S. Cl. CPC G06Q 10/0635; G06Q 10/06393

(57) ABSTRACT

An example electronic computing device can include: a processor; and a system memory, the system memory including instructions which, when executed by the processor, cause the electronic computing device to: receive data associated with risk from various sub-systems of an organization; correlate the data to develop a risk profile for the organization; and present the risk profile in a single user interface.

### BACKGROUND

Managing the many risks associated with an organization can be complex. This is particularly true for a large organization with many different sub-systems. It can be difficult to view, track, and/or quantify the risks and make decisions to effectively mitigate them.

### SUMMARY

Embodiments of the disclosure are directed to the presentation of a risk profile for an entity.

In one aspect, an example electronic computing device includes: a processor; and a system memory, the system memory including instructions which, when executed by the processor, cause the electronic computing device to: receive data associated with risk from various sub-systems of a system; correlate the data to develop a risk profile for the system; and present the risk profile in a single user interface.

In another aspect, an example method can include: receiving data associated with risk from various sub-systems of an organization; correlating the data to develop a risk profile for the organization; and presenting the risk profile in a single user interface.

The details of one or more techniques are set forth in the accompanying drawings and the description below. Other features, objects, and advantages of these techniques will be apparent from the description, drawings, and claims.

### DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 shows an example system for an organization.

FIG. 2 shows example logical components of a risk profile dashboard of the system of FIG. 1.

FIG. 3 shows an example user interface of the risk profile dashboard of FIG. 2.

FIG. 4 shows another example user interface of the risk profile dashboard of FIG. 2.

FIG. 5 shows another example user interface of the risk profile dashboard of FIG. 2.

FIG. 6 shows another example user interface of the risk profile dashboard of FIG. 2.

FIG. 7 shows another example user interface of the risk profile dashboard of FIG. 2.

FIG. 8 shows another example user interface of the risk profile dashboard of FIG. 2.

FIG. 9 shows another example user interface of the risk profile dashboard of FIG. 2.

FIG. 10 shows example components of the risk profile dashboard of FIG. 2.

### DETAILED DESCRIPTION

Various embodiments will be described in detail with reference to the drawings, wherein like reference numerals represent like parts and assemblies through the several views. Reference to various embodiments does not limit the scope of the claims attached hereto. Additionally, any examples set forth in this specification are not intended to be limiting and merely set forth the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

The examples provided herein are directed to the presentation of a risk profile for an entity.

In the examples provided herein, a dashboard is provided that presents a risk profile associated with an organization. The dashboard allows details associated with the risk profile to be organized, managed, and/or controlled to minimize the potential impact the organization.

In these examples, the dashboard provides a single view to show the risk profile. The view provides full visibility into the exposures associated with the risks, along with the ability to make meaningful decisions and execute mitigation. Tracking of the risks associated with the risk profile through the dashboard is also possible, including one or more details associated with existing risks and/or new risks. The dashboard can be further configured to manage and track mitigation efforts.

In the examples provided, the dashboard presents an interactive interface that navigates across the risk profile. The dashboard can be automated and provide correlations between various risk details to better present risk exposures and compliance across one or more lines of organization.

The data underlying the dashboard can be gathered in a semi-automated or full-automated manner. For instance, the dashboard can be programmed to automatically pull (or receive pushed) relevant data from the various sub-systems of record for the organization. The dashboard can use artificial intelligence, such as machine learning, to analyze the data and proactively and responsively provide information to mitigate the risks.

In one example, the dashboard includes various modules that provide the functionality described herein. The dashboard can include a data architecture with a database schema and data mapping across the complex data structures and sub-systems of record associated with the organization. The dashboard includes data feeds from those various sub-systems to receive updated data associated with the risks.

The dashboard further includes a user interface to present risk-associated information for the various sub-systems of the organization in a single place. This allows for navigation of the risk information in a single place. Further, the dashboard maps various risk and compliance programs and can define a user interface that is tailored to specific tasks, such as by a line of organization portfolio for the organization. Finally, the dashboard can provide forecasting and risk appetite profiles.

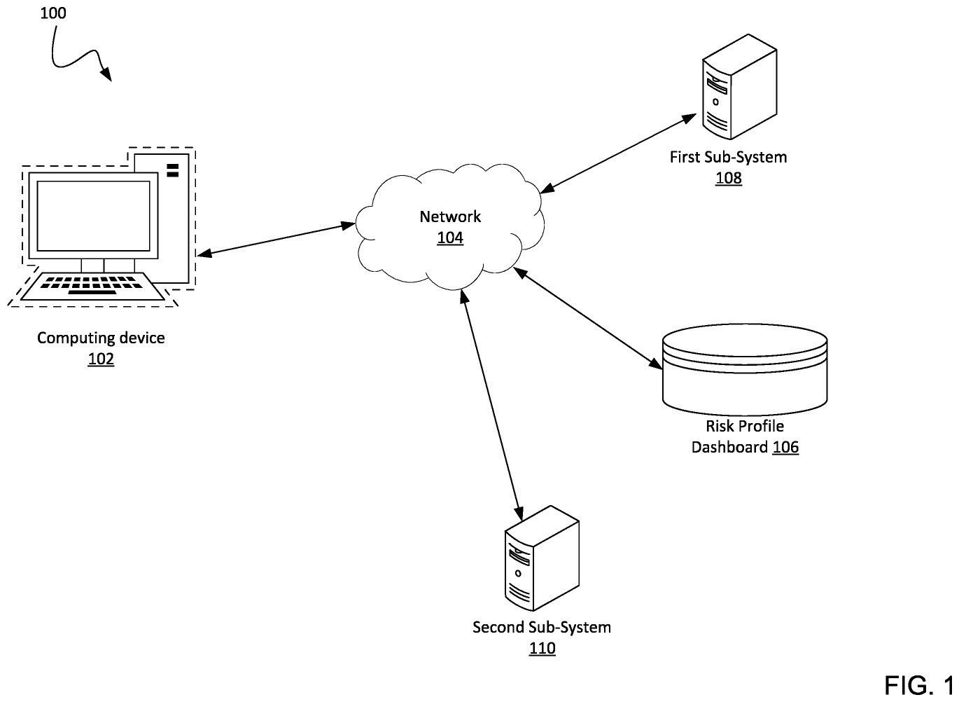

FIG. 1 illustrates an example system 100 for an organization with various first and second sub-systems 108, 110. The system 100 also includes a computing device 102, a network 104, and a risk profile dashboard 106.

In this example, the computing device 102 is programmed to access various interfaces provided by the risk profile dashboard 106. These interfaces provide risk information associated with the various sub-systems of the system 100, such as the first and second sub-systems 108, 110, as described herein. Such risk information can include one or more of the following assessment types:
Policy exception (security and non-security)—assessment of an instance that fails to comply with an existing policy;
Technology risk exception (TREX)—assessment of a technology that fails to comply with an existing policy;
Issue—generic risk;
Corrective action—generic action taken to correct a risk; and
Risk assessment—generic assessment of a risk.

Various attributes for each risk for each assessment type can be tracked. These attributes can include one or more of the following: assessment type and name; instance identifier; source type and name; application identifier and name; responsible parties; dates (due date; target date; completion date, audit date, etc.); completion percentage;

In some examples, the dashboard 106 includes a database and other data stored on one or more data storage devices.

The first and second sub-systems 108, 110 can be various sub-systems associated with the system 100 of the organization. The sub-systems can be divided up various ways. For instance, each sub-system can be associated with a different line of organization for the system 100. In other instances, each sub-system can be a different component of the information technology infrastructure. In yet other embodiments, each sub-system can be a logical division of a portion of the system 100 associated with a particular compliance program or risk for the organization. Examples of such sub-systems include access management systems, application building and deploying systems, computer network systems, audit systems, etc.

Details about with the risks associated with the first and second sub-systems 108, 110 are provided by the risk profile dashboard 106, as described further below.

The example network 104 is a computer network and can be any type of wireless network, wired network, and cellular network, including the Internet. As noted, the computing device 102 accesses the dashboard 106 via the network 104. Further, the dashboard 106 communicates with the first and second sub-systems 108, 110 via the network 104.

Although the various devices of the system 100 are depicted as single devices, in a typical environment the computing devices can be implemented as multiple devices, such as servers in server farms and/or cloud computing environments.

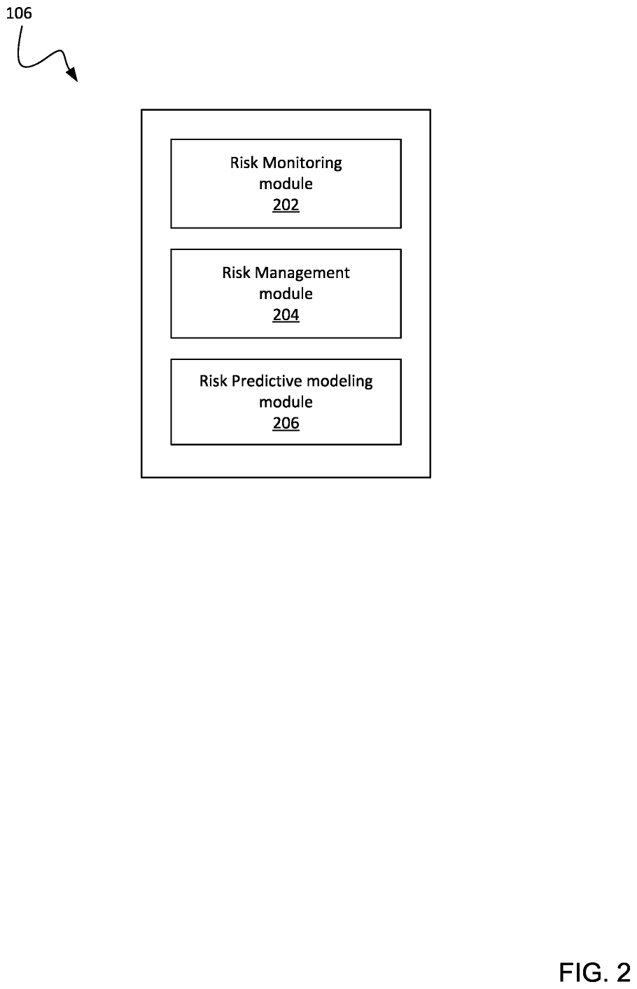

FIG. 2 illustrates example logical components of the risk profile dashboard 106. These components include a risk monitoring module 202, a risk management profile module 204, and a risk predictive modeling profile module 206.

The example risk monitoring module 202 is programmed to receive data from the various sub-systems of the system 100 of the organization. For instance, as described above, the risk monitoring module 202 can be programmed to pull (or receive pushed) data from various sub-systems of record of the system 100, like the first and second sub-systems 108, 110. The risk monitoring module 202 is further programmed to analyze and correlate the data to prepare the risk profile that is presented by the risk profile dashboard 106.

The example risk management profile module 204 is programmed to track various risks associated with the risk profile presented by the risk profile dashboard 106. For instance, the risk management profile module 204 can be programmed to ticket and track the various risks throughout the identification and mitigation efforts. Further, various aspects associated with risk management can be provided by the risk management profile module 204, such as scorecards that quantify the management of the risks and event roadmaps that provide a timeline of risk management.

The example risk predictive modeling profile module 206 is programmed to predict aspects of risk management, including the management of known and future risks. This can include an assessment risk, such as quantifying risk level and tolerances. For instance, the risk predictive modeling profile module 206 can be programmed to provide integrated organization continuity planning metrics associated with various risks.

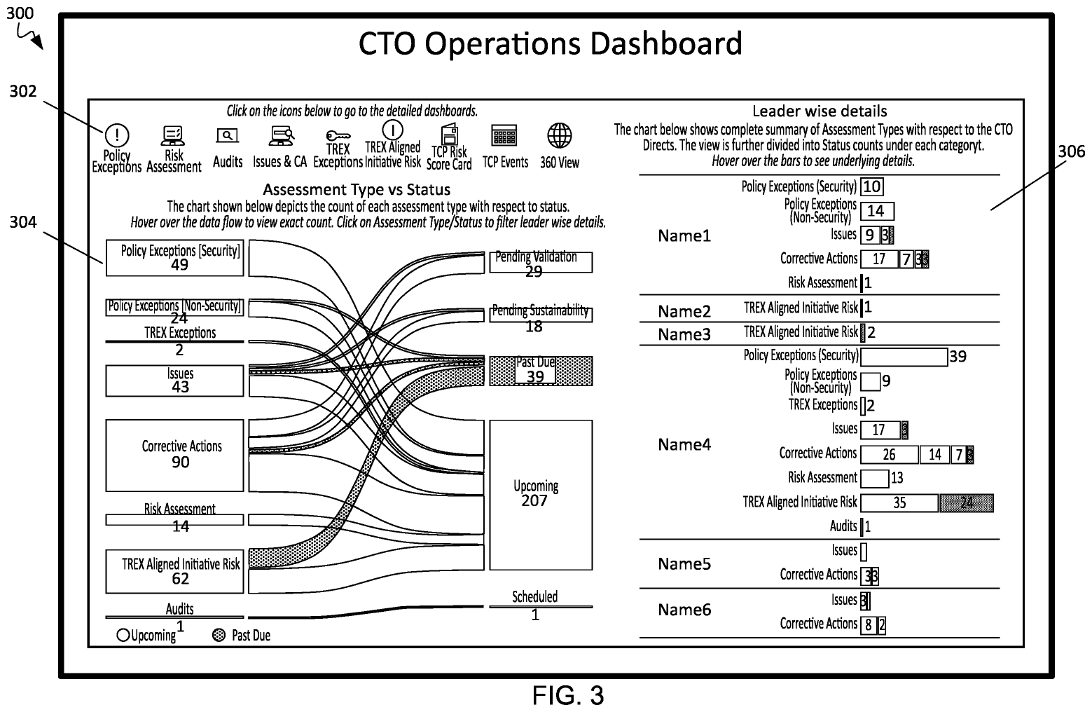

The risk monitoring module 202, the risk management profile module 204, and the risk predictive modeling profile module 206 together provide the dashboard with the risk profile. Examples of this dashboard are provided below in FIGS. 3-9.

Referring now generally to FIGS. 3-9, example interfaces of the risk profile dashboard 106 are shown. Such interfaces are advantageous in that the risk profile dashboard 106 generates a single dashboard that provides a presentation of an entire risk profile for the system 100 in one place. The dashboard is built from data that can come from many disparate sub-systems of record located throughout the system 100.

Referring now to FIG. 3, an example interface 300 of the risk profile dashboard 106 is shown, as displayed, for instance, on the computing device 102. This interface 300 provides a summary of the risk profile for the system 100 and can be tailored based upon the user. In this example, the user is the Chief Technology Officer for the organization, so the information displayed on the interface 300 is tailored appropriately.

The interface 300 includes a portion 302 with links to various other information associated with the risk profile dashboard 106. Examples of this information are shown in the following figures.

The interface 300 also includes a portion 304 with a chart depicting the count of each assessment type tracked by the risk profile dashboard 106 with respect to status. The number of risks being tracked for each assessment type is provided, and links are provided to a status (e.g., pending validation, pending sustainability, past due, upcoming, scheduled, etc.) for each of the assessment types. Upon a determination of hovering over one of the assessment types, additional details are provided. Upon a determination of selection of one of the assessment types, filtering and/or additional details are provided.

The interface 300 also includes a portion 306 with a chart depicting a summary of the assessment types with respect to the party or parties responsible for each assessment type. This includes a count of the assessment types associated with each party, along with a color-coding of status (e.g., red indicates overdue). Again, upon a determination of hovering over one of the assessment types, additional details are provided. Upon a determination of selection of one of the assessment types, filtering and/or additional details are provided.

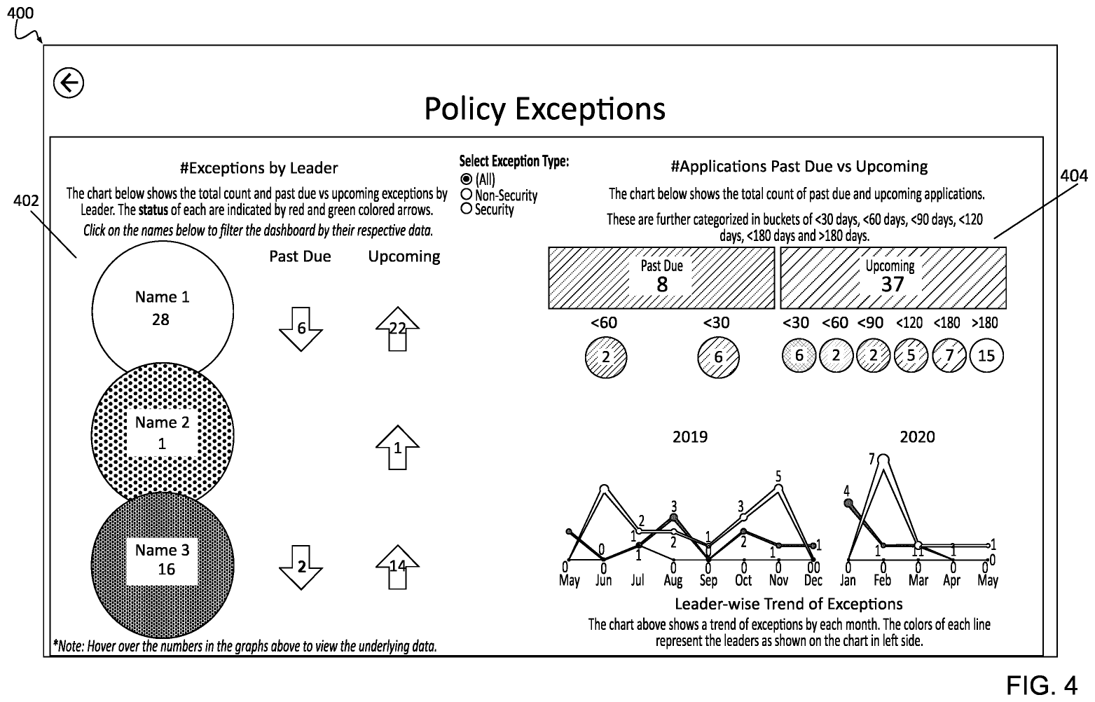

Referring now to FIG. 4, another example interface 400 of the risk profile dashboard 106 is shown, as displayed, for instance, on the computing device 102. This interface 400 provides information associated with one of the assessment types, in this instance policy exceptions.

A portion 402 of the interface 400 lists a count of the policy exceptions associated with each responsible party. In addition, a trending is provided to show how many are past due and how many are upcoming for each party. A portion 404 of the interface 400 provides a chart and bar graph showing trends for the policy exceptions, including buckets of due dates (e.g., 30 days, 60 days, 90 days, 120 days, 180 days, etc.). These are coded by color by party.

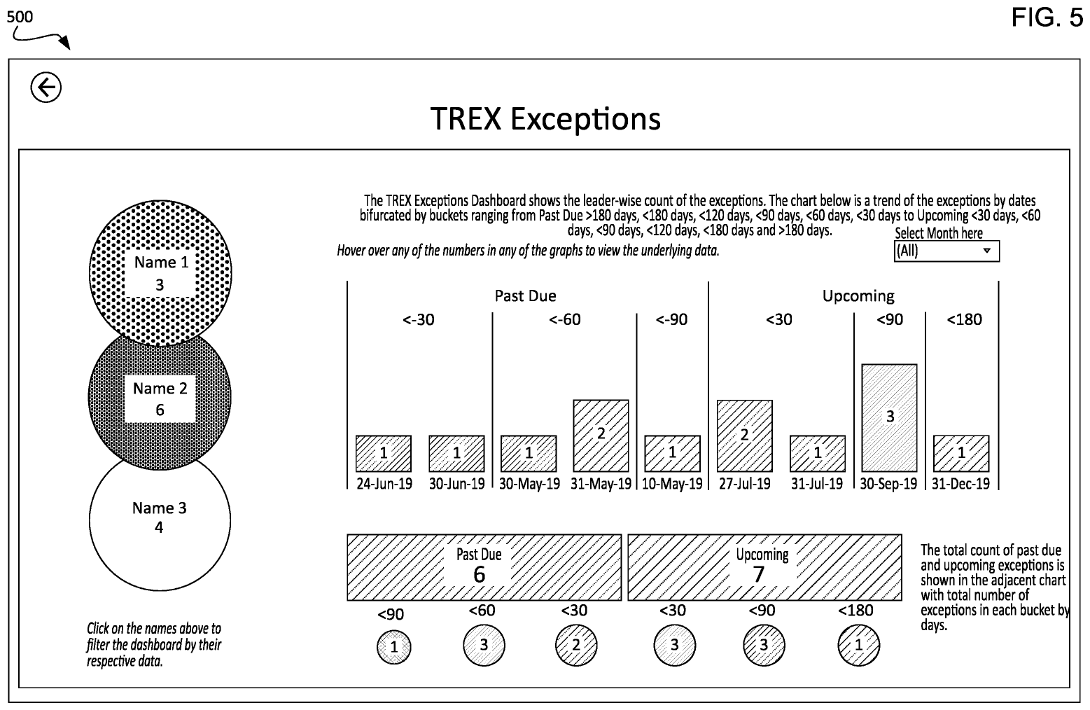

Referring now to FIG. 5, another example interface 500 of the risk profile dashboard 106 is shown, as displayed, for instance, on the computing device 102. This interface 500 provides information associated with another one of the assessment types, in this instance TREX exceptions. Like the interface 400, the interface 500 provides information about the TREX exceptions broken down by each responsible party and charting to show the TREX exceptions over time.

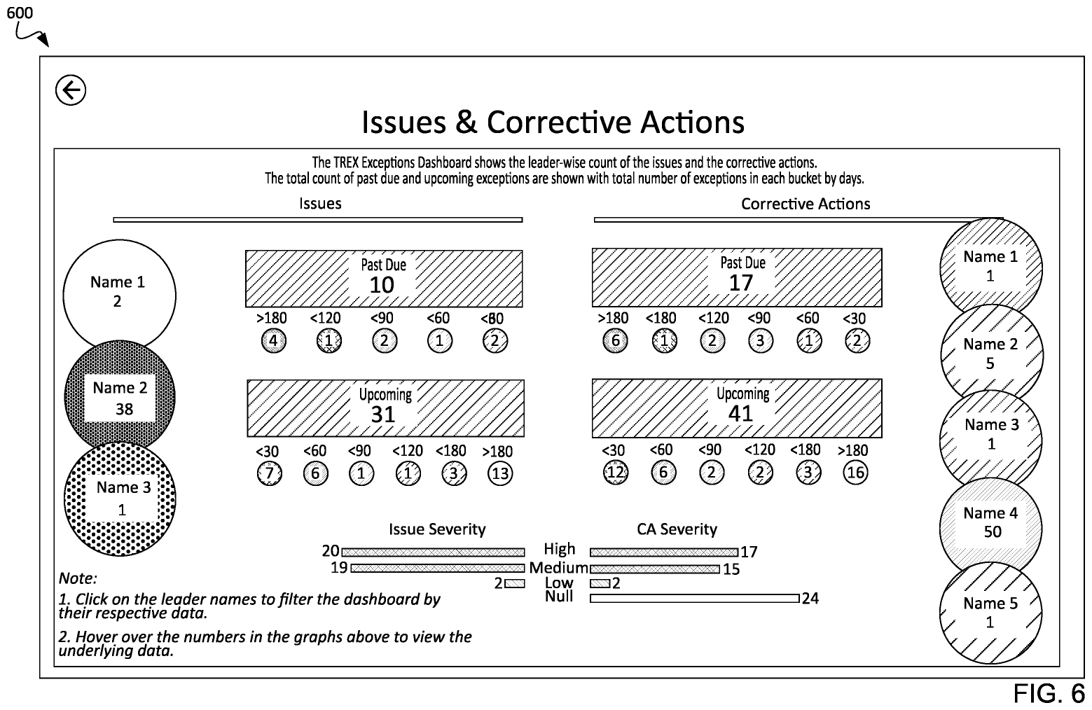

Referring now to FIG. 6, another example interface 600 of the risk profile dashboard 106 is shown, as displayed, for instance, on the computing device 102. This interface 600 provides information associated with another one of the assessment types, in this instance issues and corrective actions. Like the interfaces 400 and 500, the interface 600 provides information about the issues and corrective actions taken by each responsible party. The interface 600 also provides charting to show a severity (e.g., high, medium, low, null) associated with each of the issues and corrective actions, color-coded by the responsible party.

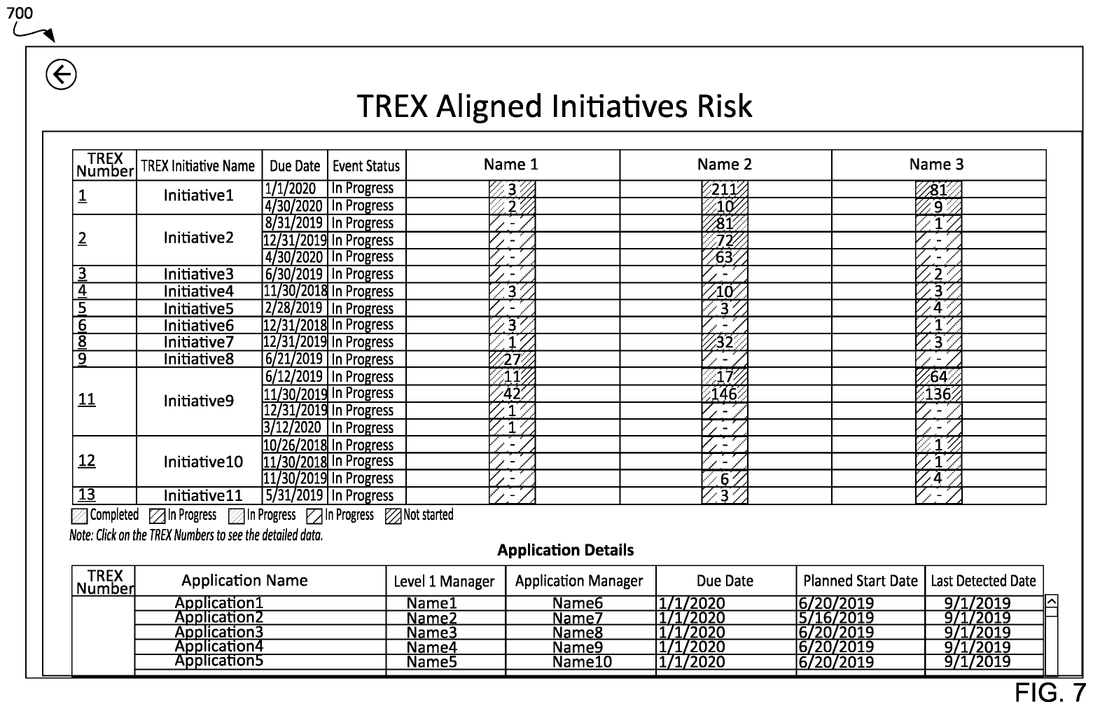

Referring now to FIG. 7, another example interface 700 of the risk profile dashboard 106 is shown, as displayed, for instance, on the computing device 102. This interface 700 provides additional details of the attributes associate the TREX initiates for the system 100. The interface 700 provides a table with information including each TREX initiative along with: due dates; event status (e.g., not started; in progress; completed); and count by each responsible party (color-coded).

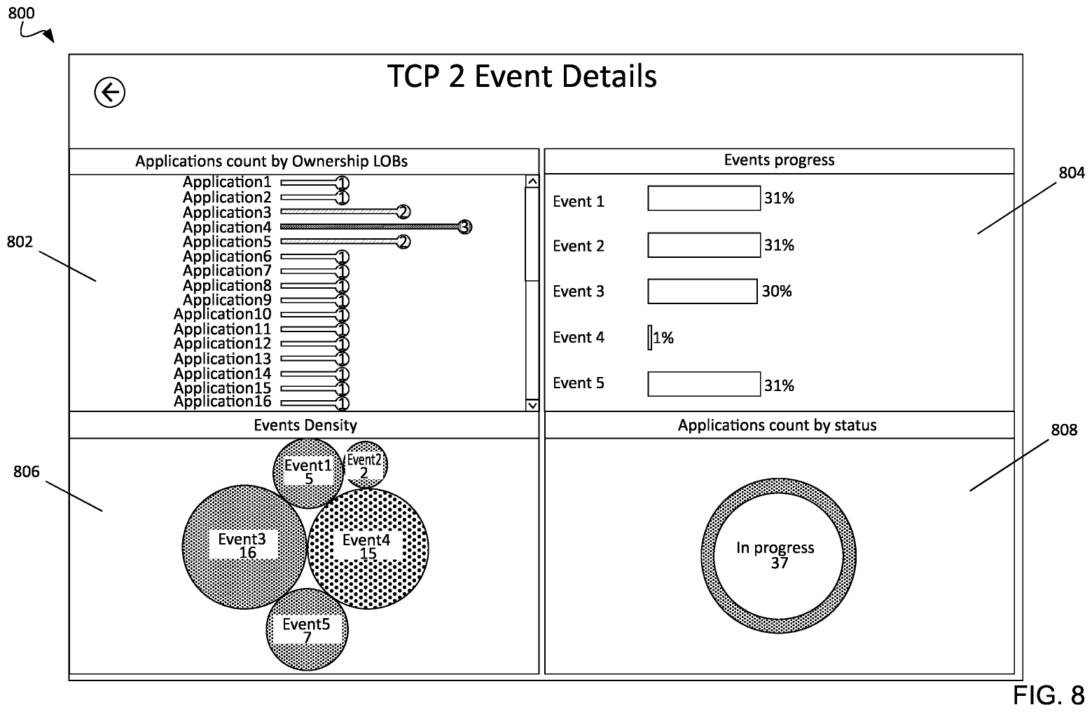

Referring now to FIG. 8, another example interface 800 of the risk profile dashboard 106 is shown, as displayed, for instance, on the computing device 102. This interface 800 provides information associated with the attributes associated with an assessment type, TCP in this instance.

In this example, the interface 800 includes a portion 802 listing the various program applications implicated by the attribute, along with a count of the number of risks associated with each application. The listing is color-coded.

A portion 804 of the interface 800 shows a list of the events associated with the attribute, along with the progress of the events (in percentage). A portion 806 shows a density plot of the different events, and a portion 808 shows a count of the status for each of the events (e.g., in progress, etc.). Other similar information can be provided.

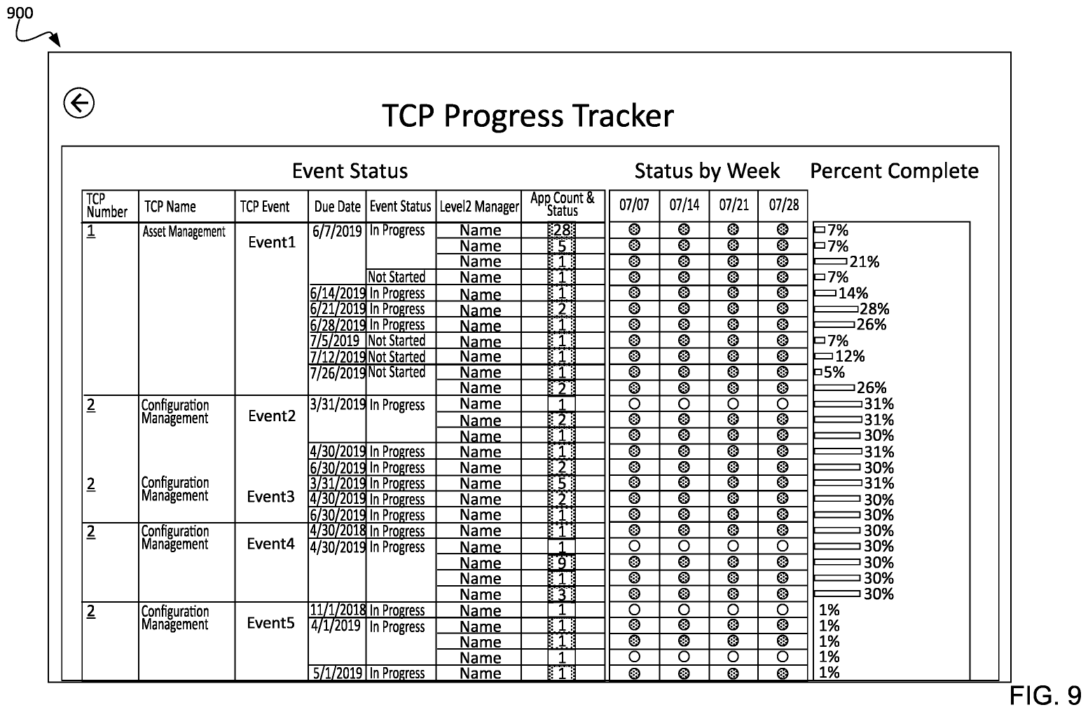

Referring now to FIG. 9, another example interface 900 of the risk profile dashboard 106 is shown, as displayed, for instance, on the computing device 102. This interface 900 provides additional details on the attributes associated with the TCP assessment type. This includes a table tracking the status of each attribute by responsible party, including an event status, a status by week, and a percent completion.

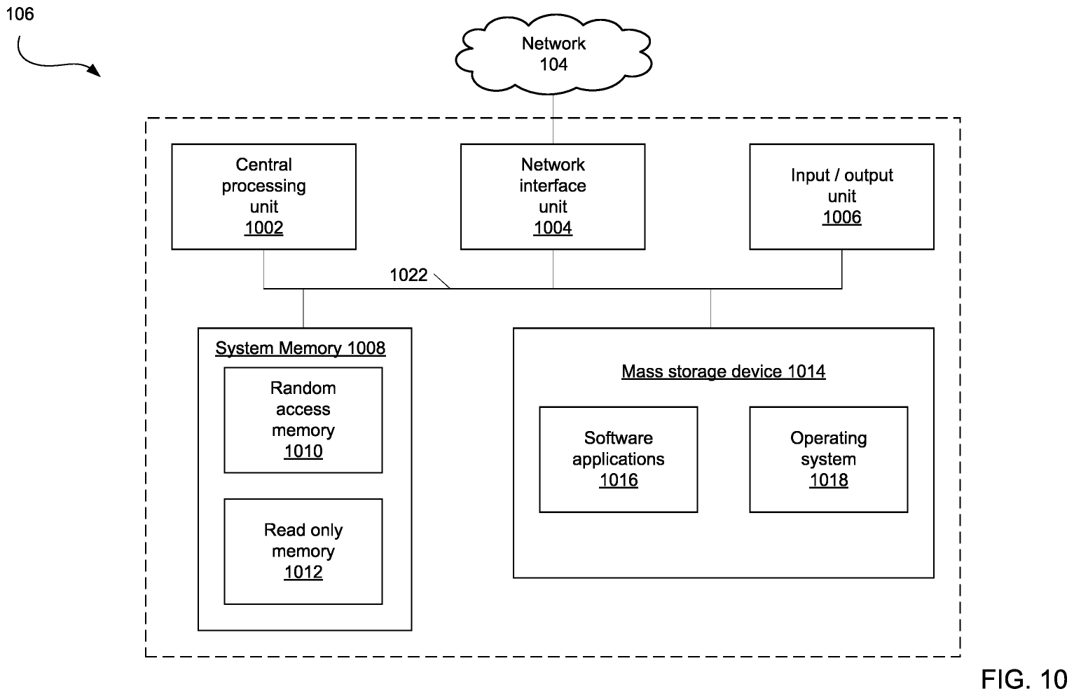

As illustrated in FIG. 10, the example risk profile dashboard 106 includes at least one central processing unit (“CPU”) 1002, also referred to as a processor, a system memory 1008, and a system bus 1022 that couples the system memory 1008 to the CPU 1002. The CPU 1002 can alternatively be a graphics processing unit (“GPU”).

The system memory 1008 includes a random access memory (“RAM”) 1010 and a read-only memory (“ROM”) 1012. A basic input/output system that contains the basic routines that help to transfer information between elements within the risk profile dashboard 106, such as during startup, is stored in the ROM 1012. The risk profile dashboard 106 further includes a mass storage device 1014. The mass storage device 1014 is able to store software instructions and data.

The mass storage device 1014 is connected to the CPU 1002 through a mass storage controller (not shown) connected to the system bus 1022. The mass storage device 1014 and its associated computer-readable data storage media provide non-volatile, non-transitory storage for the risk profile dashboard 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the risk profile dashboard 106.

According to various embodiments of the invention, the risk profile dashboard 106 may operate in a networked environment using logical connections to remote network devices through the network 104, such as a wireless network, the Internet, or another type of network. The risk profile dashboard 106 may connect to the network 1020 through a network interface unit 1004 connected to the system bus 1022. It should be appreciated that the network interface unit 1004 may also be utilized to connect to other types of networks and remote computing systems. The risk profile dashboard 106 also includes an input/output controller 1006 for receiving and processing input from a number of other devices, including a touch user interface display screen, or another type of input device. Similarly, the input/output controller 1006 may provide output to a touch user interface display screen or other type of output device.

As mentioned briefly above, the mass storage device 1014 and the RAM 1010 of the risk profile dashboard 106 can store software instructions and data. The software instructions include an operating system 1018 suitable for controlling the operation of the risk profile dashboard 106. The mass storage device 1014 and/or the RAM 1010 also store software instructions and software applications 1016, that when executed by the CPU 1002, cause the risk profile dashboard 106 to provide the functionality of the risk profile dashboard 106 discussed in this document. For example, the mass storage device 1014 and/or the RAM 1010 can store software instructions that, when executed by the CPU 1002, cause risk profile dashboard 106 to display data on the display screen of the risk profile dashboard 106.

Although various embodiments are described herein, those of ordinary skill in the art will understand that many modifications may be made thereto within the scope of the present disclosure. Accordingly, it is not intended that the scope of the disclosure in any way be limited by the examples provided.

1. An electronic computing device, comprising:
a processor; and
a system memory, the system memory including instructions which, when executed by the processor, cause the electronic computing device to:
receive data associated with risk from various sub-systems of an organization;
correlate the data to develop a risk profile for the organization; and
present one or more aspects of the risk profile in a single dashboard on a user interface, wherein the one or more aspects of the risk profile are tailored based upon a role of a viewer of the single dashboard within the organization.

2. The electronic computing device of claim 1, comprising further instructions which, when executed by the processor, cause the electronic computing device to pull the data associated with the risk from multiple sub-systems of record.

3. The electronic computing device of claim 1, comprising further instructions which, when executed by the processor, cause the electronic computing device to track multiple risks to develop the risk profile.

4. The electronic computing device of claim 1, comprising further instructions which, when executed by the processor, cause the electronic computing device to create a scorecard on the single user interface, wherein the scorecard quantifies management of risks.

5. The electronic computing device of claim 1, comprising further instructions which, when executed by the processor, cause the electronic computing device to create an event roadmap on the single user interface, wherein the event roadmap provides a timeline of risk management.

6. (canceled)

7. The electronic computing device of claim 1, comprising further instructions which, when executed by the processor, cause the electronic computing device to provide a status of a specific risk on the single user interface.

8. The electronic computing device of claim 1, comprising further instructions which, when executed by the processor, cause the electronic computing device to create a chart depicting a summary of types of risks assessed.

9. The electronic computing device of claim 8, wherein the chart includes a count of each assessment type and a respective status.

10. The electronic computing device of claim 8, wherein the chart includes a responsible party listed for each assessment type.

11. A method, comprising:
receiving data associated with risk from various sub-systems of an organization;
correlating the data to develop a risk profile for the organization; and
presenting one or more aspects of the risk profile in a single dashboard on a user interface, wherein the one or more aspects of the risk profile are tailored based upon a role of a viewer of the single dashboard within the organization.

12. The method of claim 11, further comprising pulling the data associated with the risk from multiple sub-systems of record.

13. The method of claim 11, further comprising tracking multiple risks to develop the risk profile.

14. The method of claim 11, further comprising creating a scorecard on the single user interface, wherein the scorecard quantifies management of risks.

15. The method of claim 11, further comprising creating an event roadmap on the single user interface, wherein the event roadmap provides a timeline of risk management.

16. The method of claim 11, further comprising tailoring the single user interface based upon a role of a viewer of the single user interface.

17. The method of claim 11, further comprising providing a status of a specific risk on the single user interface.

18. The method of claim 11, further comprising creating a chart depicting a summary of types of risks assessed.

19. The method of claim 18, wherein the chart includes a count of each assessment type and a respective status.

20. The method of claim 18, wherein the chart includes a responsible party listed for each assessment type.
